(19) United States
(12) Patent Application Publication
(10) Pub. No.: US 2013/0337137 A1
(43) Pub. Date: Dec. 19, 2013

(54) ANIMAL FEED ADDITIVE

(71) Applicant: Eric E. Lofquist, Chagrin Falls, OH (US)

(72) Inventor: Eric E. Lofquist, Chagrin Falls, OH (US)

(21) Appl. No.: 13/918,152

(22) Filed: Jun. 14, 2013

Related U.S. Application Data
(60) Provisional application No. 61/660,977, filed on Jun. 18, 2012.

(51) Int. Cl. A23K 1/16; A23L 1/16

(52) U.S. Cl. CPC A23K 1/1643
USPC 426/548; 426/658; 426/660; 426/665; 426/520; 426/519; 426/518

(57) ABSTRACT

A composition is disclosed comprising at least one acid and at least one sugar for use as an additive for animal feed products. The composition may be used as an alternative to molasses and other sweeteners within the animal feed. The composition disclosed herein may be prepared from discarded and surplus food products. A process for preparing the disclosed composition is also provided.

This application claims priority to U.S. Ser. No. 61/660,997, entitled ANIMAL FEED ADDITIVE, filed Jun. 18, 2012, which is incorporated herein by reference.

### BACKGROUND

In animal husbandry, many choices may exist for animal feed. Animal feed may include both compound feed and fodder. Compound feed is a commercial pelleted food, whereas fodder is an agricultural foodstuff used specifically for animal feed. Animal feed may be fed to livestock and other animals including, but not limited to, beef cattle, dairy cows, horses, mules, donkeys, sheep, goats, hogs, pigs, rabbits, chickens, turkeys, ducks, geese, alpacas, llamas, buffalo, and emu. As the human population continues expanding and developing countries become wealthier, there may be a rising demand for food of animal origin. For farmers producing this food from animals, feed can add to the cost of production. In choosing the appropriate animal feed, farmers may take into account a variety of factors in choosing a particular animal feed. The choice in animal feed may be influenced by challenges including but not limited to feed intake, fertility, health, and environmental impact. Additionally, the farmers may assess the performance, quality, safety, sustainability, and cost effectiveness in all aspects of forage utilization, digestion and metabolic physiology, and feeding behavior. The utilization of animal feed may be maximized for animal performance and economic benefits.

Animal feeds may contain a variety of materials, including, but not limited to, plant materials, animal products, and discarded products like manure and garbage. These animal feeds may also contain additives like molasses, some other type of sweetener, or both in order to increase both yield and animal compliance. The sweeteners, including molasses, may create an enhanced sensorial experience while bringing together all sensations associated with sweet and aromatic tastes and mouth feel stimulations. The sweeteners may also provide other benefits, including: 1) an increased palatability of many types of rations; 2) an improved digestibility since the energy is in the form of simple sugars; 3) increased energy for the animal; 4) a reduced dust to the animal feed; and 5) an imparted tonic effect.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, the composition described herein is an animal feed additive comprising: 1) an acid; and 2) a sugar. The acid may be provided from soda or other beverages, and the sugar may be provided from candy.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIG. 1A provides a flow diagram of the process described herein.

FIG. 1B provides a flow diagram of the process described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

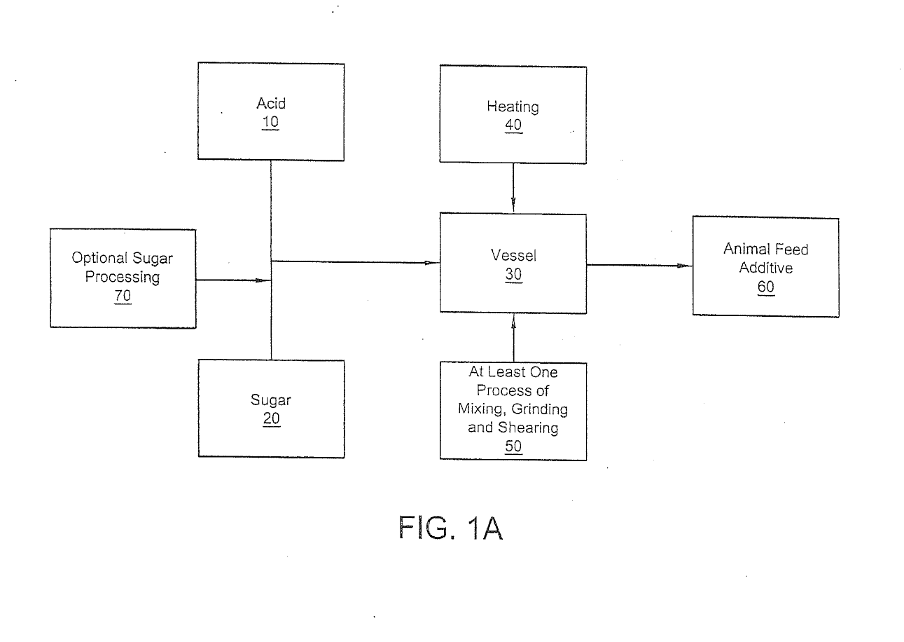

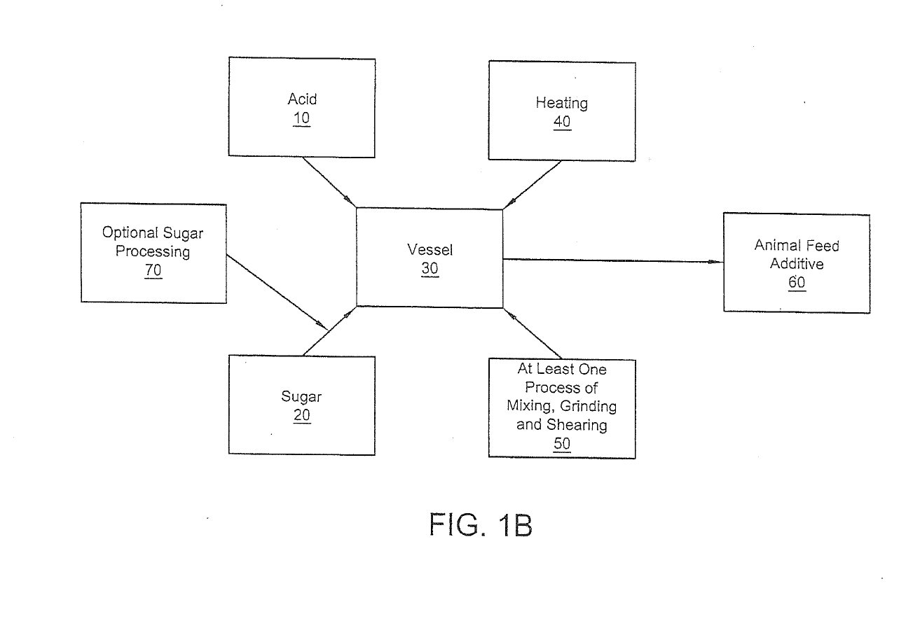

Referring now to the drawings wherein the showings are for purposes of illustrating embodiments of the described composition and process only and not for purposes of limiting the same, a composition for the animal feed additive is provided herein. Additionally, both FIG. 1A and FIG. 1B provide flow diagrams for the process of making an animal feed additive.

A composition comprising at least one acid and at least one sugar for use as an additive for animal feed products is described herein. The composition may be used as an alternative to molasses and other sweeteners within the animal feed. The animal feed additive described herein may be added to animal feed. The animal feed additive may also be fed to animals straight without being added to animal feed. The composition described herein may be prepared from discarded food products, surplus food products, or both. Also described herein is a process which can provide an animal feed additive. The process of preparing an animal feed additive comprises the steps of: 1) providing an acid and a sugar; and 2) processing the acid and the sugar to provide the animal feed additive.

An acid, as described herein, can be a chemical species that may donate protons or hydrogen ions, accept electrons, or both. Acids in solution may have a pH below 7.0 and can release hydroxyl ions in water.

Sugars, as described herein, may be a class of organic compounds having the general formula Cₘ(H₂O)ₙ. The term sugar may refer to disaccharides (e.g sucrose) and monosaccharides (e.g. fructose, glucose). Sugars can be a structural component of living cells and a source of energy in many organisms. Sugars may be classified based on the number of monosaccharide units present. The monosaccharides can join to form more complex sugars like disaccharides.

Sweetened animal feed additives may be used for several reasons. Sweeteners may be used for improving the taste of the feed for the animals, leading to increased food consumption by the animals. This increased food consumption may lead to larger animals, increasing the profitability in their sale for food consumption. Larger animals may also provide increased durability and improved show qualities. The sweeteners may also be used to enhance the well-being of the animals in that they prefer the taste and ease of digestibility. Sweeteners may also increase energy levels. Additionally, sweeteners may reduce the dusting created by animal feed, both in processing the animal feed and while feeding the animals.

The animal feed additive used for sweetening is described herein. The sugar content of the animal feed additive may be about 3% by weight to about 70% by weight. The animal feed additive can be comprised of an acid and a sugar.

The acid within the animal feed additive may be provided from at least one acid of phosphoric acid, citric acid, acetic acid, fumaric acid, lactic acid, malic acid, hydrochloric acid, and tartaric acid. Some sources of these acids may be found in food products, which may be surplus and discarded food products. Some sources of acids derived from food products can include but are not limited to sodas, beers, juices, cheeses, canned goods, frozen goods, jams, and jellies. The acid in the animal feed additive described herein may also be provided from a beverage. A beverage may include any one of various liquids for drinking. The beverage may be a discarded beverage. The beverage may also be a surplus beverage. The beverage may comprise at least one beverage of Coca-Cola®, Diet Coke®, Coca-Cola Zero®, Barq's® root beer, Tab®, Fresca®, Sprite®, Sprite Zero®, Fanta®, Pepsi-Cola®, Diet Pepsi®, Mountain Dew®, Diet Mountain Dew®, Mug® root beer, Siena Mist®, 7-Up®, Diet 7-Up®, Dr Pepper®, Diet Dr Pepper®, RC Cola®, Canada Dry® ginger ale, Vernors®, Faygo® soft drink, Sunkist®, Squirt®, ROCKSTAR®, Monster®, Gatorade®, cola, clear cola, cream soda, ginger ale, root beer, citrus soda, fruit-flavored soda, lemonade, iced tea, fruit punch, sparkling water, fruit juice, juice cocktail, juice drink, sports drink, and energy drink, but not limited thereto. The beverage may comprise a soda. Soda may be a sweet drink containing carbonated water and flavoring. Soda may also be referred to as pop, soda pop, soda water, tonic, and soft drinks. Soda may also have other regional names. The soda may also be another brand of soda other than those listed above or a generic version of a brand of soda. Within the animal feed, the beverage can be about 15% by weight to about 80% by weight of the animal feed additive. The amount of acid added to the animal feed additive may also provide a way to adjust the sugar content of the animal feed additive.

For the animal feed additive described herein, more than one acid may be used within the additive. There may be several other reasons for using more than one acid. The use of different acids from different types of beverages, for example, may provide different tastes to the animal feed additive. The taste of the animal feed additive may be tailored to the specific likes of particular animals. In addition, using more than one acid may utilize acid from discarded and surplus sources. With discarded and surplus sources, choosing a particular acid may not be an option. However, using discarded and surplus acid may decrease the raw material costs of the animal feed additive.

The sugar within the composition described herein may be sucrose, which may also be referred to as table sugar and granulated sugar. The sugar within the composition described herein may also originate from candy. Candy can be a sweet food made with sugar or syrup, and can be combined with at least one food of fruit, chocolate, and nuts. As described herein, syrup may be a liquefied form of sugar. Candy may also have a flavoring and a filling. Candy may or may not include flour or some other type of grain. The candy in the animal feed additive described herein may be provided from several different sources. The candy may be at least one candy of licorice, gummy candy, hard candy, soft candy, powdered candy, caramels, lollipops, candy liquids, sour candy, salty candy, marshmallow candy, jelly beans, candy cough drops, mints, wafers, fudges, Italian creams, nougats, peanut brittle, sugared almonds, dark chocolate, semi-sweet chocolate, milk chocolate, and white chocolate, but not limited thereto. For instance, a licorice may be Twizzlers®. Also, milk chocolate may be a Hershey's® chocolate bar, a Milky Way® bar, or a 3 Musketeers® bar. Candy may also include combinations of those candies listed herein. The candy may be about 20% by weight to about 85% by weight of the animal feed additive. The candy may be discarded candy. The candy may also be surplus candy.

For the animal feed additive described herein, more than one candy may be used within the animal feed additive. There may be several different reasons for using more than one type of candy. The use of different candies may provide different tastes to the animal feed additive, which may be tailored to the specific likes of particular animals. The use of different candies may also provide a way to adjust the sugar content of the animal feed additive. In addition, the animal feed additive may utilize candy from discarded and surplus sources. In this instance, choosing a particular candy may not be an option. However, using candy from discarded and surplus sources may decrease the raw material costs of the animal feed additive.

For the animal feed additive described herein, the ratios between the acid and sugar may be adjusted in order to provide a particular sugar content. The ratios between the acid and sugar may also be varied to assist in processing, allow for particular cost parameters, and provide a specific taste.

Besides the acid and sugar used in the animal feed additive described herein, other materials may also be added. One of these materials may include an additional sweetener. This sweetener may be comprised of at least one sweetener of white sugar, brown sugar, liquid sugar, corn syrup, high fructose corn syrup, honey, maple syrup, molasses, agave nectar, fruit concentrate, coconut sugar, stevia sweetener, aspartame, sucralose, neotame, acesulfame potassium, saccharin, sorbitol, xylitol, lactitol, mannitol, maltitol, isomalt, erythritol, arabitol, and hydrogenated starch hydrolysate, but not limited thereto. White sugar may include at least one white sugar of table sugar, regular sugar, fruit sugar, Bakers Special sugar, superfine sugar, ultrafine sugar, powdered sugar, coarse sugar, and sanding sugar. Brown sugar may include at least one brown sugar of Turbinado sugar, evaporated cane juice, light brown sugar, dark brown sugar, Muscovado sugar, and free-flowing brown sugar. Liquid sugars may include at least one liquid sugar of light-colored liquid sugar, dark-colored liquid sugar, and invert sugar. An additional sweetener may be added for several reasons, including but not limited to: 1) increasing the sugar content of the animal feed additive, 2) changing the viscosity or flow of the animal feed additive described herein, and 3) improving the overall taste of the resulting animal feed.

In one embodiment, the animal feed additive may contain soda, licorice, and chocolate. In this instance, the soda, licorice, and chocolate may be heated to about 60° C. (about 140 degrees Fahrenheit) to about 90° C. (about 194 degrees Fahrenheit) and processed to produce the animal feed additive. Processing may include at least one process of mixing, grinding, and shearing.

FIG. 1A and FIG. 1B both provide a process in which the acid 10 and the sugar 20 may be added to a vessel 30 to produce the animal feed additive 60 described herein. The process may be performed as shown in either FIG. 1A or FIG. 1B.

In FIG. 1A, the acid 10 and the sugar 20 may also be added together prior to introduction to the vessel 30. Where there is more than one acid 10 or more than one sugar 20 to be used, the acid 10 and sugar 20 may be added in any order so long as the acid 10 and the sugar 20 can be added together prior to introduction to the vessel 30. Using the process for preparing the animal feed additive 60 shown in FIG. 1A may depend on processing preferences or plant logistics.

In FIG. 1B, the acid 10 and the sugar 20 may be added separately to the vessel 30. For the process of preparing an animal feed additive 60 shown in FIG. 1B, the acid 10 and sugar 20 may be added one at a time to the vessel 30 in either order, or may be added simultaneously. Where there is more than one acid 10 or more than one sugar 20 to be used, the acid 10 and sugar 20 may be added in any order. Using the process for preparing the animal feed additive 60 shown in FIG. 1B may depend on processing preferences or plant logistics.

In addition to the process described herein, the sugar 20 may undergo optional sugar processing 70, as shown in both FIG. 1A and FIG. 1B. The optional sugar processing 70 may aid in processing the sugar 20 prior to addition to the vessel 30. The optional sugar processing 70 may include at least one process of mixing, grinding, and shearing. Besides mixing, grinding, and shearing, the sugar 20 may also be broken up into pieces, crushed, pulverized, or the like. When candy is supplied as the sugar 20, the optional sugar processing 70 may aid in breaking down the candy prior to processing within the vessel 30. Using the optional sugar processing 70 may reduce the time for the overall process described herein.

In both FIG. 1A and FIG. 1B, a process of preparing the animal feed additive 60 is described. The process of preparing the animal feed additive 60 comprises the steps of providing acid 10 and sugar 20, and then processing the acid 10 and the sugar 20. The acid may be provided from at least one acid 10 of phosphoric acid, citric acid, acetic acid, fumaric acid, lactic acid, malic acid, hydrochloric acid, and tartaric acid, but not limited thereto. The acid 10 may be provided from sodas, beers, juices, cheeses, canned goods, frozen goods, jams, and jellies. The acid 10 may come from discarded foods and also surplus foods. The acid 10 may include at least one beverage, as described above. The beverage may comprise at least one beverage of Coca-Cola®, Diet Coke®, Coca-Cola Zero®, Barq's® root beer, Tab®, Fresca®, Sprite®, Sprite Zero®, Fanta®, Pepsi-Cola®, Diet Pepsi®, Mountain Dew®, Diet Mountain Dew®, Mug® root beer, Sierra Mist®, 7-Up®, Diet 7-Up®, Dr Pepper®, Diet Dr Pepper®, RC Cola®, Canada Dry® ginger ale, Vernors®, Faygo® soft drink, Sunkist®, Squirt®, Rockstar®, Monster®, Gatorade®, cola, clear cola, cream soda, ginger ale, root beer, citrus soda, fruit-flavored soda, lemonade, iced tea, fruit punch, sparkling water, fruit juice, juice cocktail, juice drink, sports drink, and energy drink, but not limited thereto. The beverage may include soda, as described above. The sugar 20 within the composition described herein may be sucrose, which may also be referred to as table sugar and granulated sugar. The sugar 20 may also be provided from candy. The sugar 20 may be at least one sugar 20 of licorice, gummy candy, hard candy, soft candy, powdered candy, caramels, lollipops, candy liquids, sour candy, salty candy, marshmallow candy, jelly beans, candy cough drops, mints, wafers, fudges, Italian creams, nougats, peanut brittle, sugared almonds, dark chocolate, semi-sweet chocolate, milk chocolate, and white chocolate, but not limited thereto. For instance, a licorice may be Twizzlers®. Also, milk chocolate may be a Hershey's® chocolate bar, a Milky Way® bar, or a 3 Musketeers® bar. The candy may be about 20% by weight to about 85% by weight of the animal feed additive. The candy may be discarded candy. The candy may also be surplus candy. The process shown in FIGS. 1A and 1B may include the addition of more than one acid 10. The process shown in FIGS. 1A and 1B may also include the addition of more than one sugar 20.

Within the vessel 30, heating 40 may occur. Heating 40 during processing within the vessel 30 may have a temperature of at least about 30° C. (about 86 degrees Fahrenheit). Heating 40 during the processing may also have a temperature of about 60° C. (about 140 degrees Fahrenheit) to about 90° C. (about 194 degrees Fahrenheit). Heating 40, however, may be an optional step. Alternatively, the processing may be run at ambient temperature.

Besides the heating 40 within the vessel 30, at least one process of mixing, grinding, and shearing 50 may also occur within the vessel 30. If more than one process of mixing, grinding, and shearing 50 occur, then the processes may occur simultaneously or at different times, and may occur in any order. At least one process of mixing, grinding, and shearing 50 may be optional. Both the heating 40 and at least one process of mixing, grinding, and shearing 50 may also occur simultaneously or at different times, and may occur in any order.

The processes including but not limited to heating 40 and at least one process of mixing, grinding, and shearing 50 may allow the animal feed additive 60 to be homogenous. The processes including but not limited to heating 40 and at least one process of mixing, grinding, and shearing 50 may also allow the animal feed additive 60 to be flowable. The time for the processing the animal feed additive 60 may vary. For example, the processing time may be about one hour. Also, the processing time may also be about twelve hours.

Besides providing at least one acid 10 and at least one sugar 20, the process for preparing the animal feed additive 60 may further comprise the step of adding at least one sweetener of white sugar, brown sugar, liquid sugar, corn syrup, high fructose corn syrup, honey, maple syrup, molasses, agave nectar, fruit concentrate, coconut sugar, stevia sweetener, aspartame, sucralose, neotame, acesulfame potassium, saccharin, sorbitol, xylitol, lactitol, mannitol, maltitol, isomalt, erythritol, arabitol, and hydrogenated starch hydrolysate, but not limited thereto. White sugar may include table sugar, regular sugar, fruit sugar, Bakers Special sugar, superfine sugar, ultrafine sugar, powdered sugar, coarse sugar, and sanding sugar. Brown sugar may include Turbinado sugar, evaporated cane juice, light brown sugar, dark brown sugar, Muscovado sugar, and free-flowing brown sugar. Liquid sugars may include light-colored liquid sugar, dark-colored liquid sugar, and invert sugar. Providing an additional sweetener may occur either before, after, or simultaneously with: 1) the addition of the acid 10 and sugar 20 to the vessel 30, 2) heating 40, or 3) at least one process of mixing, grinding, and shearing 50.

Additionally, the processing described herein may also include the step of freezing the animal feed additive 60. The animal feed additive 60 may be frozen for storage purposes, prolonging the shelf life, or both.

The following example illustrates the present composition and methods in a way that it can be practiced, but as such these examples should not be interpreted as limitations upon the overall scope of the methods described herein.

### EXAMPLE 1

Pepsi® was heated to 62° C. (about 145 degrees Fahrenheit). Then, Twizzlers® and chocolate were broken into smaller pieces to aid in dissolution. The Twizzlers® and chocolate were then added to the Pepsi® over an hour while mixing. The content of the mixture was about 40% Pepsi®, about 30% chocolate, and about 30% Twizzlers®. The sugar content was about 34%. An analysis using Karl Fischer titration showed that the mixture was about 39% water.

The implementations have been described, hereinabove. It will be apparent to those skilled in the art that the above methods and apparatuses may incorporate changes and modifications without departing from the general scope of what is described herein. It is intended to include all such modifications and alterations in so far as they come within the scope of the appended claims or the equivalents thereof.

What is claimed is:

1. An animal feed additive comprising:
an acid; and
a sugar.

2. The animal feed additive of claim 1, wherein said acid is provided from at least one acid of phosphoric acid, citric acid, acetic acid, fumaric acid, lactic acid, malic acid, hydrochloric acid, and tartaric acid.

3. The animal feed additive of claim 1, wherein said acid is provided from a beverage.

4. The animal feed additive of claim 3, wherein said beverage comprises at least one beverage of Coca-Cola®, Diet Coke®, Coca-Cola Zero®, Barq's® root beer, Tab®, Fresca®, Sprite®, Sprite Zero®, Fanta®, Pepsi-Cola®, Diet Pepsi®, Mountain Dew®, Diet Mountain Dew®, Mug® root beer, Siena Mist®, 7-Up®, Diet 7-Up®, Dr Pepper®, Diet Dr Pepper®, RC Cola®, Canada Dry® ginger ale, Vernors®, Faygo® soft drink, Sunkist®, Squirt®, Rockstar®, Monster®, Gatorade®, cola, clear cola, cream soda, ginger ale, root beer, citrus soda, fruit-flavored soda, lemonade, iced tea, fruit punch, sparkling water, fruit juice, juice cocktail, juice drink, sports drink, and energy drink.

5. The animal feed additive of claim 3, wherein said beverage comprises a soda.

6. The animal feed additive of claim 3, wherein said beverage is provided from a surplus beverage or a discarded beverage.

7. The animal feed additive of claim 3, wherein said beverage is about 15% by weight to about 80% by weight of said animal feed additive.

8. The animal feed additive of claim 1, wherein said sugar is provided from a candy.

9. The animal feed additive of claim 8, wherein said candy is at least one candy of licorice, gummy candy, hard candy, soft candy, powdered candy, caramels, lollipops, candy liquids, sour candy, salty candy, marshmallow candy, jelly beans, candy cough drops, mints, wafers, fudges, Italian creams, nougats, peanut brittle, sugared almonds, dark chocolate, semi-sweet chocolate, milk chocolate, and white chocolate.

10. The animal feed additive of claim 9, wherein said licorice is Twizzlers®.

11. The animal feed additive of claim 8, wherein said candy is a surplus candy or a discarded candy.

12. The animal feed additive of claim 8, wherein said candy is about 20% by weight to about 85% by weight of said animal feed additive.

13. The animal feed additive of claim 1, further comprising:
at least one sweetener of white sugar, brown sugar, liquid sugar, corn syrup, high fructose corn syrup, honey, maple syrup, molasses, agave nectar, fruit concentrate, coconut sugar, stevia sweetener, aspartame, sucralose, neotame, acesulfame potassium, saccharin, sorbitol, xylitol, lactitol, mannitol, maltitol, isomalt, erythritol, arabitol, and hydrogenated starch hydrolysate.

14. The animal feed additive of claim 1, wherein said animal feed additive has a sugar content, and said sugar content is about 3% by weight to about 70% by weight.

15. An animal feed additive comprising:
soda;
licorice; and
chocolate;
wherein said animal feed additive is heated to about 60° C. to about 90° C. and is processed by at least one process of mixing, grinding, and shearing.

16. A process of preparing an animal feed additive comprising the step of:
processing acid and sugar to produce said animal feed additive.

17. The process of claim 16, wherein said acid is provided from at least one acid of phosphoric acid, citric acid, acetic acid, fumaric acid, lactic acid, malic acid, hydrochloric acid, and tartaric acid.

18. The process of claim 16, wherein said acid is provided from a beverage.

19. The process of claim 18, wherein said beverage comprises at least one beverage of Coca-Cola®, Diet Coke®, Coca-Cola Zero®, Barq's® root beer, Tab®, Fresca®, Sprite®, Sprite Zero®, Fanta®, Pepsi-Cola®, Diet Pepsi®, Mountain Dew®, Diet Mountain Dew®, Mug® root beer, Siena Mist®, 7-Up®, Diet 7-Up®, Dr Pepper®, Diet Dr Pepper®, RC Cola®, Canada Dry® ginger ale, Vernors®, Faygo® soft drink, Sunkist®, Squirt®, ROCKSTAR®, Monster®, Gatorade®, cola, clear cola, cream soda, ginger ale, root beer, citrus soda, fruit-flavored soda, lemonade, iced tea, fruit punch, sparkling water, fruit juice, juice cocktail, juice drink, sports drink, and energy drink.

20. The process of claim 18, wherein said beverage comprises a soda.

21. The process of claim 16, said wherein said sugar is provided from a candy.

22. The process of claim 21, wherein said candy is at least one candy of licorice, gummy candy, hard candy, soft candy, powdered candy, caramels, lollipops, candy liquids, sour candy, salty candy, marshmallow candy, jelly beans, candy cough drops, mints, wafers, fudges, Italian creams, nougats, peanut brittle, sugared almonds, dark chocolate, semi-sweet chocolate, milk chocolate, and white chocolate.

23. The process of claim 16, further comprising the step of:
adding a sweetener comprising at least one sweetener of white sugar, brown sugar, liquid sugar, corn syrup, high fructose corn syrup, honey, maple syrup, molasses, agave nectar, fruit concentrate, coconut sugar, stevia sweetener, aspartame, sucralose, neotame, acesulfame potassium, saccharin, sorbitol, xylitol, lactitol, mannitol, maltitol, isomalt, erythritol, arabitol, and hydrogenated starch hydrolysate.

24. The process of claim 16, wherein said processing is performed at a temperature of about 60° C. to about 90° C.

25. The process of claim 16, wherein said processing comprises at least one process of mixing, grinding, and shearing.
